(19) United States
(12) Patent Application Publication
(10) Pub. No.: US 2025/0379433 A1
(43) Pub. Date: Dec. 11, 2025

(54) Portable Trailer Power Box Device

(71) Applicant: Steve Gallaway, Bastrop, TX (US)

(72) Inventor: Steve Gallaway, Bastrop, TX (US)

(21) Appl. No.: 19/233,730

(22) Filed: Jun. 10, 2025

Related U.S. Application Data
(60) Provisional application No. 63/658,128, filed on Jun. 10, 2024.

(51) Int. Cl. H02G 3/08; B60R 16/033; B65H 75/30; F04B 35/04; G07C 5/08

(52) U.S. Cl. CPC H02G 3/08; B65H 75/30; F04B 35/04; B60R 16/033; G07C 5/0808

(57) ABSTRACT

A portable trailer power box device is provided. The device is designed to deliver both electrical signals and compressed air to semi-trailers independent of a tractor unit. The device comprises a housing comprising at least one spool that allows for extension and retraction of a pigtail power cable and an air hose. The pigtail power cable includes a 7-pin female connector compliant with SAE J560 standards and simulates tractor electrical outputs, while the cable features a durable, cold-weather-rated polyurethane jacket. The air hose includes a connector that interfaces with a reciprocating connector of an attachment, which may include a glad hand or air chuck. The air system is powered by an internal compressor managed through a rocker switch and adjustable regulator, with pressure data presented on a digital display. The display is electrically linked to the power cable and indicates electrical diagnostics, including pin-specific voltage, current, and fault conditions.

### CROSS-REFERENCE TO RELATED APPLICATION

The present application claims priority to, and the benefit of, U.S. Provisional Application No. 63/658,128, which was filed on Jun. 10, 2024, and is incorporated herein by reference in its entirety.

### FIELD OF THE INVENTION

The present invention relates generally to the field of portable power units. More specifically, the present invention relates to a device designed to deliver both electrical signals and compressed air to semi-trailers independent of a tractor unit. Accordingly, the present disclosure makes specific reference thereto. Nonetheless, it is to be appreciated that aspects of the present invention are also equally applicable to other like applications, devices, and methods of manufacture.

### BACKGROUND

Mechanics are frequently required to diagnose and repair electrical and pneumatic systems on trailers in locations where access to a semi-truck or external power source is unavailable. These repair scenarios often occur in remote yards, shop floors, or roadside environments where trailer systems cannot be activated using conventional tractor connections. Without access to electrical power and air pressure, mechanics must either delay repairs or transport the trailer to a fully equipped facility, which results in increased downtime, elevated operational costs, and inefficiencies in fleet management. Furthermore, performing electrical diagnostics without powered trailer circuits is unreliable and restricts the ability to test critical subsystems such as anti-lock braking systems (ABS) and lighting configurations. Similarly, the inability to pressurize air systems limits the mechanic's capacity to check emergency braking functions or tire pressure levels. Traditional workarounds, including external battery packs or portable compressors, often lack the integration, durability, or diagnostic functionality required in such applications. These fragmented tools also demand multiple setup procedures, which further reduces overall productivity. A unified and portable system that offers both electrical and pneumatic functionalities is essential to streamline diagnostic and maintenance workflows for trailers operating independently of tractor units.

Therefore, there exists a long-felt need in the art for a portable trailer power box device that enables both electrical and pneumatic diagnostics without requiring a semi-truck connection. There also exists a long-felt need in the art for a portable trailer power box device that incorporates an integrated air hose and compressor system for air delivery in remote environments. Moreover, there exists a long-felt need in the art for a portable trailer power box device that consolidates power output, air pressure, and diagnostic display functionality into a single, portable housing for efficient on-site trailer servicing.

The subject matter disclosed and claimed herein, in one embodiment thereof, comprises a portable trailer power box device. The device is designed to deliver both electrical signals and compressed air to semi-trailers independent of a tractor unit. The device comprises a housing comprising at least one spool that allows for extension and retraction of a pigtail power cable and an air hose. The pigtail power cable includes a 7-pin female connector compliant with SAE J560 standards and simulates tractor electrical outputs, while the cable features a durable, cold-weather-rated polyurethane jacket. The air hose includes a connector that interfaces with a reciprocating connector of an attachment, which may include a glad hand or air chuck. The air system is powered by an internal compressor managed through a rocker switch and adjustable regulator, with pressure data presented on a digital display. The display is electrically linked to the power cable and indicates electrical diagnostics, including pin-specific voltage, current, and fault conditions. The device further comprises an internal rechargeable battery, a multicolor LED power indicator, a charging port, and an integrated storage drawer for accessory containment. The device is configured to be operated through a stepwise method involving connection, activation, regulation, and monitoring of both air and electrical outputs during maintenance procedures.

In this manner, the portable trailer power box device of the present invention accomplishes all the forgoing objectives and provides mechanics with a device for powering and diagnosing trailer systems without dependence on a tractor. The inclusion of a pigtail power cable with a compliant connector enables accurate simulation of tractor electrical signals, facilitating diagnostics of lighting and ABS systems. The integrated compressor and air hose allow air delivery for testing pneumatic components such as brakes and tire systems. The built-in display and regulator controls enable real-time feedback and operational precision, while the durable housing and portable design support field use. These combined features resolve the inefficiencies and limitations posed by the lack of power and air access in remote trailer repair environments.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a portable trailer power box device. The device is designed to supply both electricity and air pressure to semi-trailers independently of a semi-truck, enabling diagnostics and maintenance in remote or non-vehicular locations such as yards, shop floors, or roadside areas.

The device is comprised of a housing that comprises at least one spool, each potentially including a guide bracket configured to align a cable or hose during use and storage, and at least one locking mechanism to secure the spool against unintentional movement.

The device is further comprised of a pigtail power cable featuring a 7-pin female connector for interfacing with a standard trailer electrical plug. This cable simulates electrical signals from a tractor unit, facilitating diagnostics of lighting, ABS, and other trailer subsystems. The cable is constructed to SAE J560 standards and features a durable, cold-weather-rated polyurethane jacket.

An air hose is also included, attachable to a second spool, and terminates in a connector that couples with a corresponding connector of an attachment. The attachment may be a glad hand or air chuck, allowing for air delivery to trailer systems. The connectors may include quick-connect, push-to-connect, or threaded types.

The device is additionally comprised of a control configured to regulate the output of the glad-hand attachment. This control may be a mechanical, toggle, or digital actuator, and is preferably a rocker switch for selective operation.

The device may include an internal compressor configured to supply pressurized air through the air hose. A regulator control allows adjustment of the output pressure, and a digital display provides real-time pressure output monitoring.

The display is also configured to show electrical diagnostic information, including voltage, current, and continuity data per pin, as well as fault indicators such as open or short circuits, thereby integrating pneumatic and electrical diagnostics in a single interface. Power is supplied by an internal rechargeable battery, which may be recharged via a port on the housing. A multicolor LED power indicator light provides visual feedback on battery status or condition.

A method of using the device includes providing the device with its main components, unwinding and connecting the pigtail power cable to a trailer plug, unwinding and connecting the air hose to an attachment, activating the compressor, adjusting the regulator, actuating the air control, and monitoring electrical and pneumatic diagnostic data on the display.

Accordingly, the portable trailer power box device of the present invention is particularly advantageous as it provides mechanics with a device for powering and diagnosing trailer systems without dependence on a tractor. The inclusion of a pigtail power cable with a compliant connector enables accurate simulation of tractor electrical signals, facilitating diagnostics of lighting and ABS systems. The integrated compressor and air hose allow air delivery for testing pneumatic components such as brakes and tire systems. The built-in display and regulator controls enable real-time feedback and operational precision, while the durable housing and portable design support field use. These combined features resolve the inefficiencies and limitations posed by the lack of power and air access in remote trailer repair environments.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a top perspective view of one potential embodiment of a portable trailer power box device of the present invention in accordance with the disclosed architecture;

FIG. 2 illustrates an enhanced perspective view of one potential embodiment of a portable trailer power box device of the present invention in accordance with the disclosed architecture;

FIG. 3 illustrates a top perspective view of one potential embodiment of a portable trailer power box device of the present invention in accordance with the disclosed architecture; and

FIG. 4 illustrates a flowchart of a method of using one potential embodiment of a portable trailer power box device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a portable trailer power box device that enables both electrical and pneumatic diagnostics without requiring a semi-truck connection. There also exists a long-felt need in the art for a portable trailer power box device that incorporates an integrated air hose and compressor system for air delivery in remote environments. Moreover, there exists a long-felt need in the art for a portable trailer power box device that consolidates power output, air pressure, and diagnostic display functionality into a single, portable housing for efficient on-site trailer servicing.

The present invention, in one exemplary embodiment, is comprised of a portable trailer power box device. The device delivers both electrical power and air pressure to semi-trailers without requiring connection to a semi-truck, supporting diagnostic and maintenance procedures in remote or off-site locations such as yards, shop floors, or roadside areas.

The device includes a housing that incorporates at least one spool. Each spool may feature a guide bracket to maintain proper alignment of a cable or hose during deployment and retraction, along with a locking mechanism designed to prevent unintended movement of the spool.

The device further incorporates a pigtail power cable equipped with a 7-pin female connector that interfaces with a standard trailer electrical plug. This configuration replicates tractor-generated electrical signals, enabling diagnostic testing of trailer lighting, ABS, and other electrical systems. The cable is constructed to SAE J560 standards and features a polyurethane jacket that is abrasion-resistant and rated for cold-weather conditions.

An air hose may be mounted on a separate spool. The hose terminates in a connector that mates with a corresponding fitting on an attachment, which may include a glad hand or air chuck for air delivery to trailer systems. The connectors may be of quick-connect, push-to-connect, or threaded design types.

To control air flow, the device is equipped with a control component for regulating output through the glad hand attachment. This control may take the form of a mechanical switch, toggle, or digital actuator, with a rocker switch preferred for ease of use.

An internal compressor may be integrated within the device to generate and deliver compressed air through the air hose. Output pressure can be adjusted using a regulator control, and a digital display enables real-time monitoring of pressure output.

The display is also configured to present electrical diagnostic data, including voltage, current, and continuity for each pin, as well as fault conditions such as shorts or open circuits. This integration of pneumatic and electrical monitoring into one interface is supported by an internal rechargeable battery, which can be recharged via a port on the housing. Battery status is indicated using a multicolor LED power light.

A method of using the device involves preparing the device with its key components, deploying and connecting the pigtail power cable to the trailer plug, deploying and connecting the air hose to an appropriate attachment, activating the compressor, setting the pressure with the regulator, toggling the air control, and observing diagnostic data on the display.

As a result, the portable trailer power box device offers a highly beneficial solution by enabling technicians to test and service trailer systems without needing a tractor unit. The combination of a compliant pigtail power cable for accurate electrical simulation, an integrated compressor and air hose for pneumatic testing, and real-time monitoring via a digital display enhances diagnostic efficiency. The rugged construction and portable design make the device well-suited for field applications, effectively addressing the challenges of trailer servicing in areas without ready access to power or air.

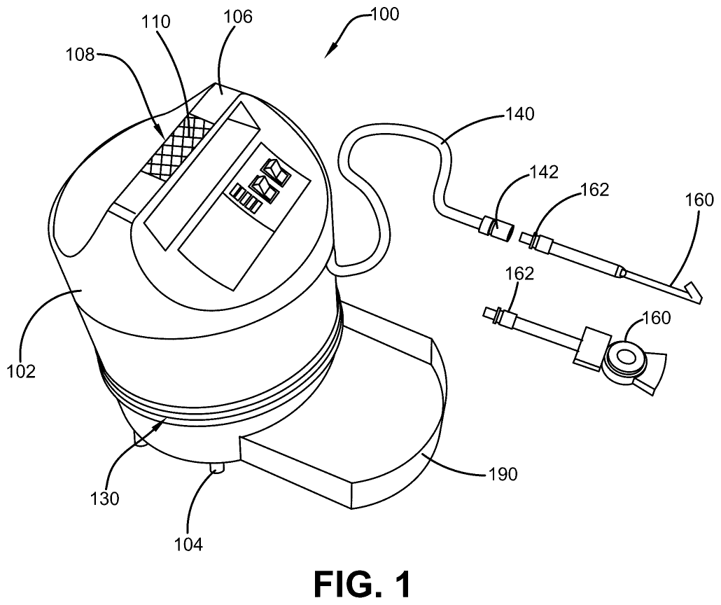

Referring initially to the drawings, FIG. 1 illustrates a top perspective view of one potential embodiment of a portable trailer power box device 100 of the present invention in accordance with the disclosed architecture. The device 100 is designed to provide both electricity and air pressure to semi-trailers without the need for a semi-truck. As a result, the device 100 can be used during the repair process to allow comprehensive diagnostics and maintenance to be performed in remote yards, shop floors, or roadside conditions where a semi-truck may not be available.

The device 100 is comprised of a housing 102. In one embodiment, the housing 102 is comprised of at least one oil-resistant rubber foot 104 that enhances stability and provides protection against abrasive surfaces or slick flooring. For improved portability, the housing 102 may include at least one handle 106 of any type, such as but not limited to an integrated handle, a telescoping handle, a collapsible handle, etc. In one embodiment, the handle 106 may be comprised of a non-slip grip area 108 made from non-slip material, such as but not limited to thermoplastic elastomer (TPE), silicone rubber, or over molded polyurethane. The grip area 108 (and/or handle 106) may be comprised of a grip texture 110, such as but not limited to knurled ridges, crosshatch embossing, or linear grooves to promote a secure grip during lifting and relocation.

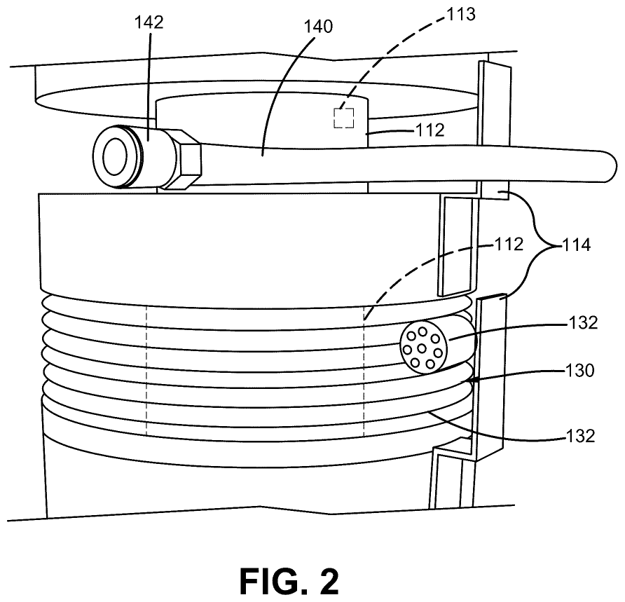

The housing 102 is further comprised of at least one spool 112, as seen in FIG. 2. In one embodiment, each spool 112 may be comprised of at least one guide bracket 114 configured to direct the alignment of a cable 130 and/or hose 140 during extension and retraction. The guide bracket 114 may be configured to prevent tangling, twisting, or kinking during deployment or storage. Each spool 112 may be comprised of at least one locking mechanism 113, such as but not limited to a ratchet-based lock, a rotating cam detent, or a spring-loaded brake to secure the spool 112 in a fixed position and prevent unintentional unwinding of cable 130 and/or hose 140.

The spool 112 may be of any type, such as but not limited to a manual hand-crank spool, an automatic retractable spool, a motorized reel spool, etc. Each spool 112 is preferably round in shape to maintain a consistent bend radius and prevent sharp creases or kinks in the cable 130 and/or hose 140 during storage and operation. The spools 112 may be mounted internally or externally to the housing 102 and may be oriented horizontally or vertically depending on spatial and ergonomic design preferences.

The device 100 is further comprised of a pigtail power cable 130, as seen in FIG. 2. The cable 130 is comprised of a 7-pin female connector 132 configured to mate with a standard trailer male electrical plug. The cable 130 is configured to simulate electrical signals typically provided by a tractor unit, enabling diagnostics of trailer lighting circuits, ABS systems, and other onboard electrical subsystems. The cable 130 is preferably constructed in accordance with SAE J560 specifications and is further comprised of a cold-weather-rated, abrasion-resistant polyurethane jacket 134 designed to resist cracking, cuts, and UV degradation. In one embodiment, the cable 130 may be fixedly or removably attached to a first spool 112.

The device 100 is also comprised of an air hose 140. The hose 140 may be fixedly or removably attached to a second spool 112. The hose 140 is comprised of a connector 142 that connects to a reciprocating connector 162 of an attachment 160. The connectors 142,162 may be of any type, such as but not limited to a pair of quick-connect fittings, a pair of push-to-connect couplings, a pair of threaded pneumatic connectors, etc., to facilitate reliable air delivery and case of connection. In various embodiments, the attachment 160 may be in the form of a glad hand connector configured for coupling to a trailer's emergency air supply line and/or an air chuck compatible with pneumatic tire valves or diagnostic air ports for inflation or pressure testing purposes.

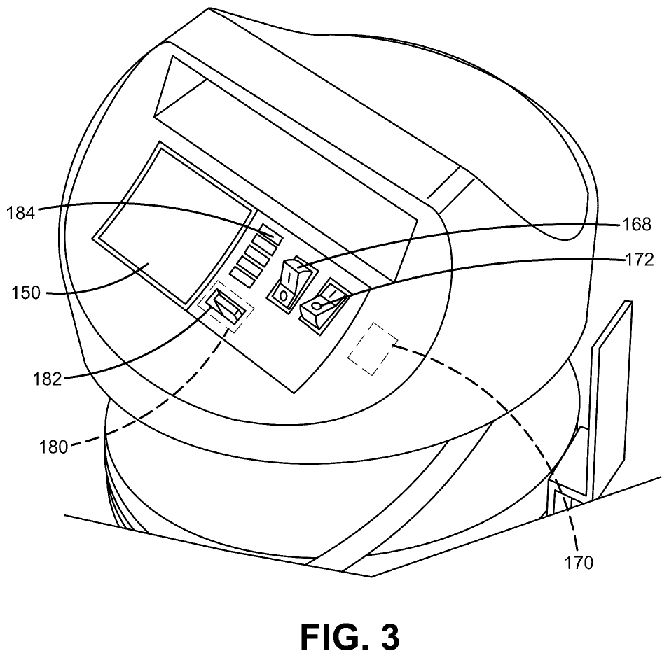

In one embodiment, the device 100 is comprised of a control 168 (as seen in FIG. 3) configured to regulate the output of the glad hand attachment 160. The control 168 may be any type of actuator, such as but not limited to a mechanical lever, toggle switch, or digital interface, and is preferably in the form of a rocker switch. The control 168 allows an operator to selectively activate or deactivate the air supply through the glad-hand connector for precise operational control.

The device 100 may also be comprised of an internal compressor 170 configured to generate and deliver compressed air through the air hose 140. An adjustable regulator control 172 may permit user control of output pressure levels. The digital display 150 may show real-time pressure output from the compressor 170 for user monitoring. The display 150 is also configured to indicate electrical diagnostic information in real time. The display 150 is electrically connected to the power cable 130 and is configured to show pin-specific voltage, current, and continuity data. The display 150 may also indicate fault conditions such as open circuits or short circuits. In addition, the display 150 may show real-time compressor pressure values to unify pneumatic and electrical diagnostics into a single user interface.

The device 100 is powered by an internal rechargeable battery 180, as seen in FIG. 3. The battery 180 may be recharged via a charging port 182 located on the housing 102. In one embodiment, the device 100 is further comprised of an illuminated power indicator light 184. The light 184 may be comprised of a multicolor LED that changes based on the battery charge status or battery health condition, providing the user with quick visual feedback.

To improve tool organization and convenience, the device 100 may include an integrated storage drawer 190 that is built into the housing 102. The drawer 190 may be of any type, such as but not limited to a sliding rail drawer, a hinged access compartment, or a friction-fit utility drawer for storing auxiliary components such as replacement connectors, tools, or testing adapters.

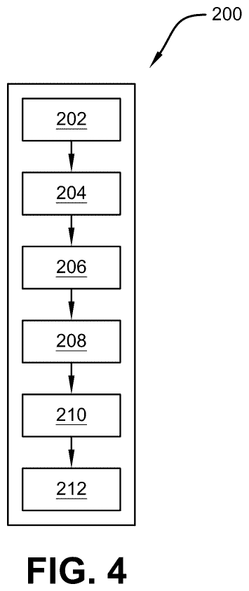

The present invention is also comprised of a method of using 200 the device 100, as seen in FIG. 4. First, a device 100 is provided comprised of a housing 102, at least one spool 112, a pigtail power cable 130 with a 7-pin female connector 132, an air hose 140 with a connector 142, an internal compressor 170, and a rechargeable battery 180 [Step 202]. Then, the pigtail power cable 130 can be unwound from the first spool 112, and the 7-pin female connector 132 can be connected to a standard trailer male electrical plug to simulate electrical signals [Step 204]. Next, the air hose 140 can be unwound from the second spool 112 and connected via connector 142 to a reciprocating connector 162 of an attachment 160, such as a glad-hand connector or air chuck, to facilitate air delivery to the trailer system [Step 206]. Then, the internal compressor 170 can be activated, and a regulator control 172 can be adjusted to set the desired output pressure level through the air hose 140 and attachment 160 [Step 208]. Next, the control 168 can be actuated to enable or disable the air supply as needed for diagnostic or maintenance purposes [Step 210]. Then, the digital display 150 can be monitored to observe real-time voltage, current, and continuity information from the electrical system as well as compressor pressure data for pneumatic diagnostics [Step 212].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “portable trailer power box device” and “device” are interchangeable and refer to the portable trailer power box device 100 of the present invention.

Notwithstanding the foregoing, the portable trailer power box device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the portable trailer power box device 100 as shown in the FIGS. are for illustrative purposes only, and that many other sizes and shapes of the portable trailer power box device 100 are well within the scope of the present disclosure. Although the dimensions of the portable trailer power box device 100 are important design parameters for user convenience, the portable trailer power box device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A portable trailer power box device comprising:
a housing;
a first spool mounted to the housing;
a second spool mounted to the housing;
a pigtail power cable attached to the first spool, the pigtail power cable comprising a 7-pin female connector;
an air hose attached to the second spool, the air hose comprising a connector configured to connect to a reciprocating connector of an attachment; and
an internal compressor housed within the housing and configured to deliver compressed air through the air hose.

2. The portable trailer power box device of claim 1, wherein the housing is comprised of a foot.

3. The portable trailer power box device of claim 1, wherein the housing is comprised of a handle.

4. The portable trailer power box device of claim 1 further comprised of a guide bracket.

5. The portable trailer power box device of claim 1, wherein the attachment is comprised of a glad hand.

6. The portable trailer power box device of claim 1, wherein the attachment is comprised of an air chuck.

7. The portable trailer power box device of claim 1, wherein the housing is comprised of a storage drawer.

8. A portable trailer power box device comprising:
a housing;
a first spool mounted to the housing;
a second spool mounted to the housing;
a pigtail power cable attached to the first spool, the pigtail power cable comprising a 7-pin female connector configured to connect to a trailer male electrical plug;
an air hose attached to the second spool, the air hose comprising a connector configured to connect to a reciprocating connector of an attachment;
an internal compressor housed within the housing and configured to deliver compressed air through the air hose;
a rechargeable battery housed within the housing and configured to power the device; and
a digital display electrically connected to the pigtail power cable and configured to show a real-time electrical diagnostic data and a pressure data of the internal compressor.

9. The portable trailer power box device of claim 8, wherein the attachment is comprised of a glad hand.

10. The portable trailer power box device of claim 8, wherein the attachment is comprised of an air chuck.

11. The portable trailer power box device of claim 8, wherein the housing is comprised of a storage drawer.

12. The portable trailer power box device of claim 8, wherein the first spool is comprised of a manual hand-crank spool, an automatic retractable spool, or a motorized reel spool.

13. The portable trailer power box device of claim 8 further comprised of a charging port.

14. The portable trailer power box device of claim 8 further comprised of a power indicator light.

15. The portable trailer power box device of claim 8 further comprised of a handle.

16. The portable trailer power box device of claim 15, wherein the handle is comprised of a grip area.

17. The portable trailer power box device of claim 8, wherein the first spool is comprised of a locking mechanism.

18. The portable trailer power box device of claim 8, wherein the connector and the reciprocating connector are comprised of a pair of quick connectors.

19. The portable trailer power box device of claim 8 further comprising a control configured to selectively activate or deactivate air delivery through the attachment.

20. A method of using a portable trailer power box device, the method comprising the following steps:
providing a portable trailer power box device comprised of a housing, a first spool, a second spool, a pigtail power cable with a 7-pin female connector, an air hose with a connector, an internal compressor, and a rechargeable battery;
unwinding the pigtail power cable from the first spool and connecting the 7-pin female connector to a trailer male electrical plug;
unwinding the air hose from the second spool and connecting the connector to a reciprocating connector of an attachment;
activating the internal compressor and adjusting a regulator control to set a desired output pressure level;
actuating a control to enable or disable the air supply; and
monitoring a digital display to observe a real-time voltage, current, a continuity, and a pressure data of the internal compressor.
